(19) United States
(12) Patent Application Publication
(10) Pub. No.: US 2023/0098272 A1
(43) Pub. Date: Mar. 30, 2023

(54) METHOD AND APPARATUS FOR PULSED LASER BEAM CONTROL IN LASER SHOCK PEENING PROCESS

(71) Applicants: Tianyi Michael YAO, Worthington, OH (US); Jeff L. DULANEY, Dublin, OH (US); Keith GLOVER, Dublin, OH (US); Daniel MERRIFIELD, Dublin, OH (US); Mark E. O'LOUGHLIN, Galloway, OH (US); LSP Technologies, Inc., Dublin, OH (US)

(72) Inventors: Tianyi Michael Yao, Worthington, OH (US); Jeff L Dulaney, Dublin, OH (US); Keith Glover, Dublin, OH (US); Daniel Merrifield, Dublin, OH (US); Mark E. O'Loughlin, Galloway, OH (US)

(73) Assignee: LSP Technologies, Inc., Dublin, OH (US)

(21) Appl. No.: 17/905,925

(22) PCT Filed: Mar. 7, 2021
(86) PCT No.: PCT/US21/21273

§ 371 Date: Sep. 8, 2022

Related U.S. Application Data
(60) Provisional application No. 62/987,172, filed on Mar. 9, 2020.

(51) Int. Cl. H01S 3/11; H01S 3/0941; H01S 3/131; H01S 3/00; H01S 3/13; H01S 3/23; G02F 1/03

(52) U.S. Cl. CPC H01S 3/11; H01S 3/0941; H01S 3/1312; H01S 3/0078; H01S 3/1305; H01S 3/0064; H01S 3/1304; H01S 3/2316; G02F 1/0305

(57) ABSTRACT

An apparatus is provided, the apparatus comprising: (i) a diode-pumped solid-state laser oscillator configured to generate a pulsed laser beam having predefined beam characteristics corresponding to a current setting selection of a controller; and (ii) an amplifier configured to amplify an energy and modify a beam profile of the pulse laser beam. A beam detector is coupled to the generated beam to monitor a combination of: (i) a beam pulse width; (ii) a beam diameter; and (iii) an energy level, and generates an error signal to be sent back as a feedback signal to the controller. The controller configures the current source to output a correction current to tune the DPSSL oscillator, the wave plate, and the first polarizer to rotate a correction polarization angle and adjust the energy amplification or temporal profile to within a defined performance tolerance.

### CROSS REFERENCE TO RELATED APPLICATIONS

This application claims priority from U.S. Provisional Patent Application No. 62/987,172, filed on Mar. 9, 2020, which is incorporated by reference herein in its entirety.

### BACKGROUND

Laser shock peening, also known as “laser peening” and “LSP,” a substitute or complementary process for traditional shot peening, is a cold working process used to produce a deep (e.g., more than 1 mm) compressive residual stress layer and modify mechanical properties of materials by impacting the material with enough force to create plastic deformation. The residual stresses created by the laser peening process increase a material's resistance to fatigue and stress, and thereby significantly increase the life of laser peened parts. Laser peening uses high energy laser pulses to generate a plasma plume and cause a rapid rise of pressure on the surface of a part. This pressure creates and sustains a high-intensity shockwave, which propagates into the surface of the part. The shockwave generated by laser peening induces cold work into the microstructure of the part material and contributes to the increased performance of the part.

As the shockwave travels into the part, some of the energy of the wave is absorbed during the plastic deformation of the part material. This is also known as cold working. Laser peening typically uses a laser pulse width of about 8 nanoseconds (ns) to about 40 ns. A typical spot diameter for a laser beam in laser peening is about 1.0 mm to about 8.0 mm.

Laser pulse width is typically defined by a pulse width, which is measured at half of the pulse's peak intensity. For a Gaussian shaped pulse, the pulse energy may be approximated by an integral of the area (i.e., power over time duration) under the pulse. Therefore, for a fixed energy output, a narrower pulse width laser beam having a sharper rise time at a leading edge of the pulse may provide a higher shocking pressure on the surface of a part in laser peening.

### SUMMARY

In one aspect, an apparatus for pulsed laser beam control is provided, the apparatus comprising: a diode-pumped solid-state laser (DPSSL) oscillator configured to generate and output a pulsed laser beam having predefined beam characteristics corresponding to a current setting selection of a controller, wherein the controller in response to the current setting selection, controls a current source to output a current to tune the DPSSL oscillator to generate a first laser beam having a pulse width within a defined tolerance, a first energy, a first spatial profile, and a first temporal profile; an optical filter configured to modify a received modified first laser beam having a modified pulse width (PW2) with a second temporal profile to output a second laser beam having a second energy, a second spatial profile, and the second temporal profile; and a multi-stage amplifier configured to output an output laser beam after beam energy amplifications and beam profile modifications, the multi-stage amplifier comprising: a first stage configured to amplify and modify the second laser beam to output a third laser beam having a third energy and a third temporal profile; and a second stage configured to amplify and modify the third laser beam to output a fourth laser beam having a fourth energy and a fourth temporal profile, wherein the fourth laser beam substantially maintains the pulse width (PW1) or the modified pulse width (PW2) within the defined tolerance.

In another aspect, a method for pulsed laser beam control is provided, the method comprising: generating and outputting, by a DPSSL oscillator, a pulsed laser beam having predefined beam characteristics corresponding to a current setting selection of a controller; in response to the current setting selection, the controller controlling a current source to output a current to tune the DPSSL oscillator to generate a first laser beam having a pulse width (PW1) within a defined tolerance, a first energy, a first spatial profile, and a first temporal profile; modifying, by an optical filter, a received modified first laser beam having a modified pulse width (PW2) with a second temporal profile to output a second laser beam having a second energy, a second spatial profile, and the second temporal profile; and amplifying a beam energy and modifying a beam profile by a multi-stage amplifier to output an output laser beam, the amplifying and the modifying comprising: amplifying and modifying the second laser beam, by a first stage, to output a third laser beam having a third energy and a third temporal profile; and amplifying and modifying the third laser beam, by a second stage, to output a fourth laser beam having a fourth energy and a fourth temporal profile, wherein the fourth laser beam substantially maintains the pulse width (PW1) or the modified pulse width (PW2) within the defined tolerance.

### BRIEF DESCRIPTION OF THE FIGURES

The accompanying figures, which are incorporated in and constitute a part of the specification, illustrate various example systems and are used merely to illustrate various example aspects. In the figures, like elements bear like reference numerals.

FIG. 1A is a schematic diagram of an apparatus for pulsed laser beam generation and adjustment for laser peening.

FIG. 1B is an example method of pulsed laser beam generation and adjustment for laser peening a target part.

FIG. 2 is a schematic diagram of an example diode-pumped solid-state laser (DPSSL) oscillator.

FIG. 3 is a graph of an example output of a DPSSL oscillator.

FIG. 4 is a graph depicting variable pulse width current and attenuation characteristics of a DPSSL oscillator.

FIG. 5 is a graph depicting variable pulse width current and power characteristics of a DPSSL oscillator.

FIG. 6 is a graph of an example temporal modification to a laser beam.

FIG. 7 is a schematic diagram of an example optical filter.

FIG. 8 is a graph of an example spatial modification to a laser beam.

FIG. 9 is a schematic diagram of an example amplifier.

FIG. 10 is a schematic diagram of an example beam delivery device and laser peening cell.

### DETAILED DESCRIPTION

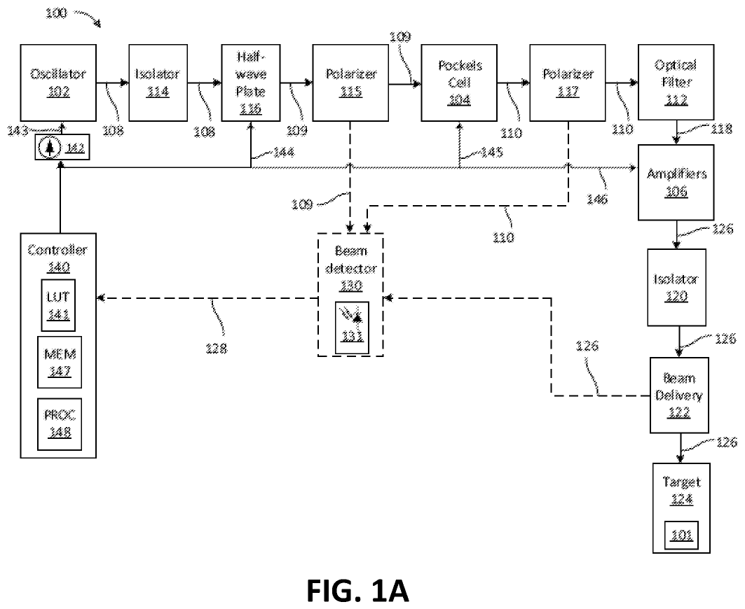

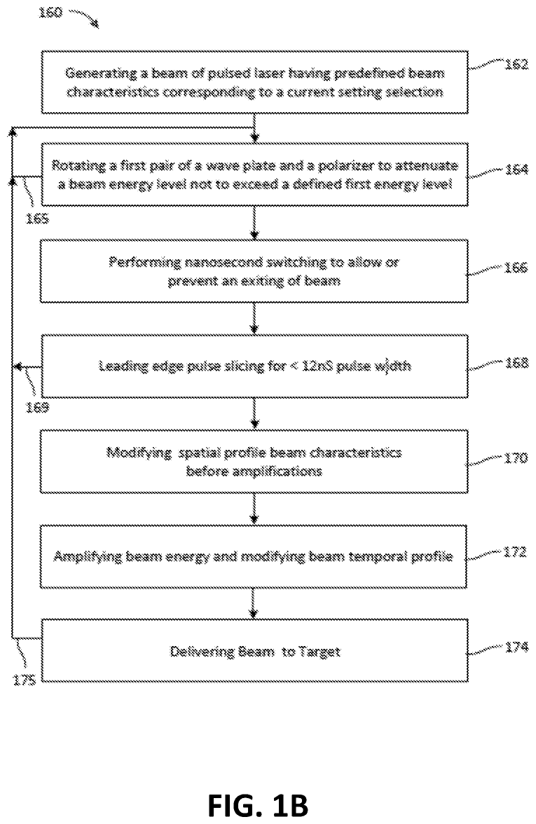

FIG. 1A illustrates an example apparatus 100 used in laser peening. The apparatus 100 is operative to produce and output a pulsed laser beam to a target part 101 for laser peening of the target part 101.

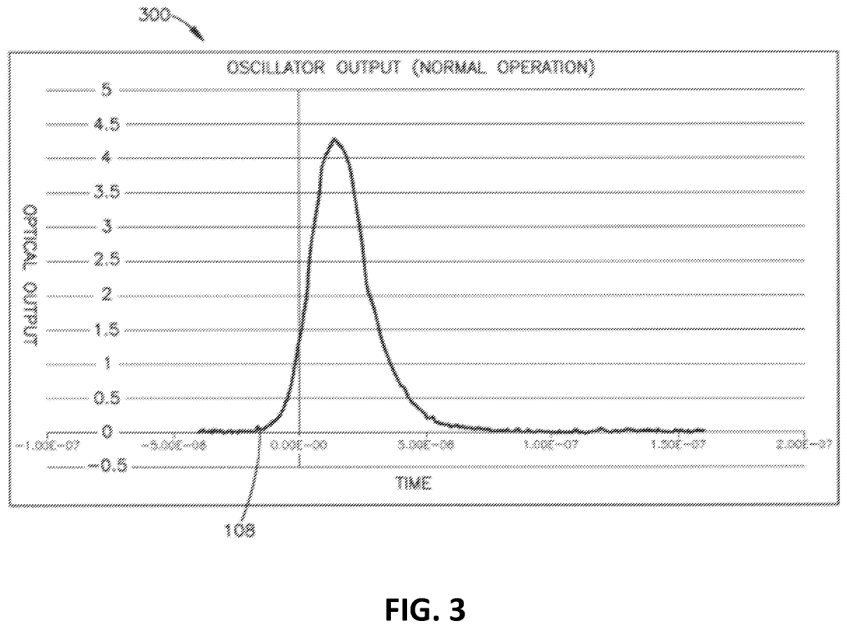

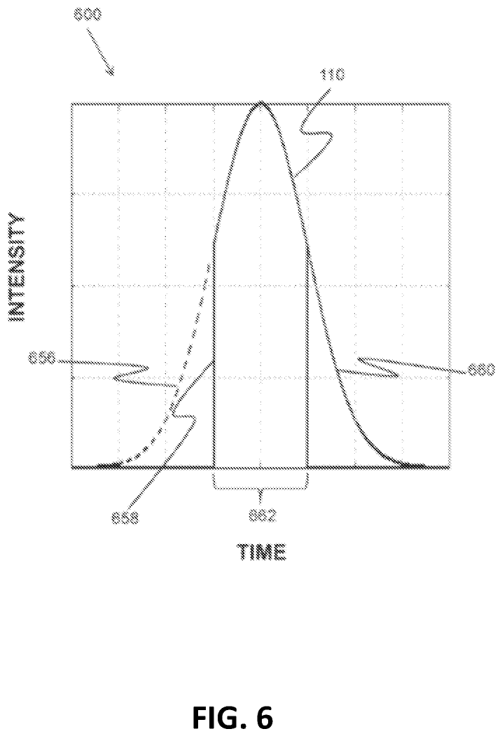

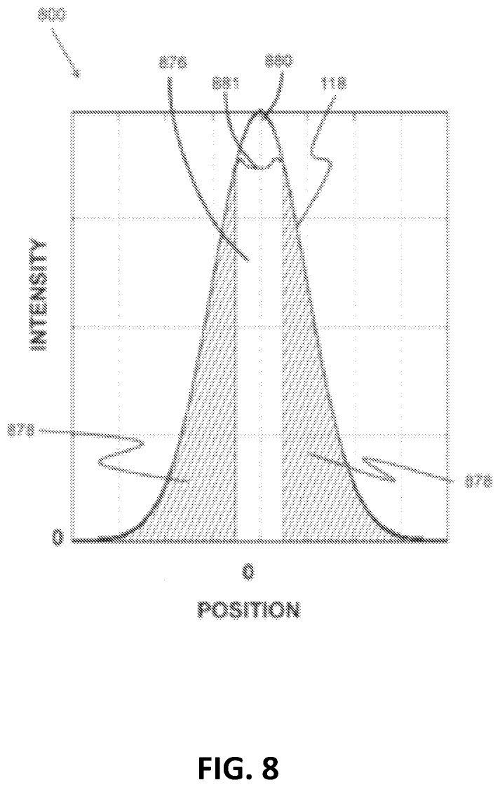

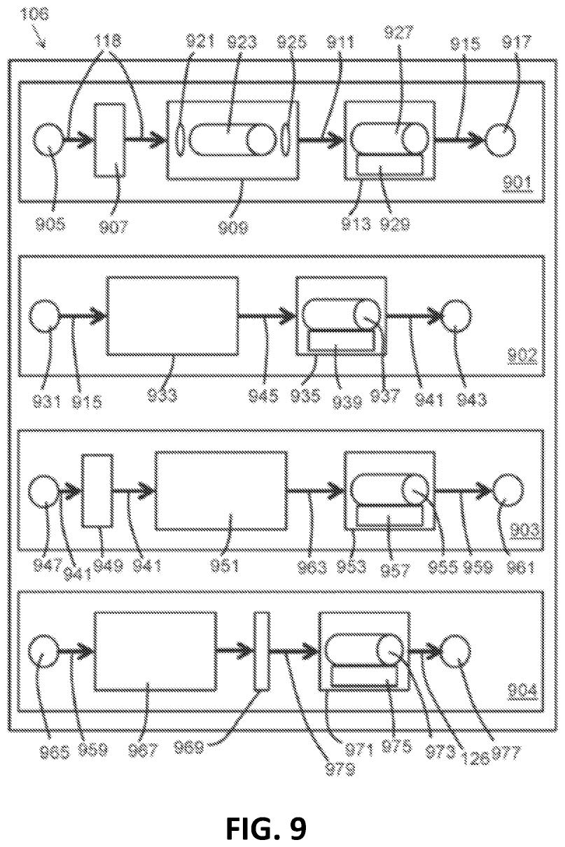

The apparatus 100 for pulsed laser beam generation may include a DPSSL oscillator 102 configured to generate and output a pulsed laser beam having predefined beam characteristics corresponding to a current setting selection (such as based on a look up table LUT 141) of a controller 140, wherein the controller 140 in response to the current setting selection, controls a current source 142 to output a current 143 (or a correction current) to tune the DPSSL oscillator 102 to generate a first beam 108 having a pulse width PW1 (e.g., 12-30 nanoseconds) within a defined tolerance, a first energy, a first spatial profile (substantially Gaussian, see FIGS. 3 and 6), and a first temporal profile. An optical filter 112 may be configured to modify a received modified first beam 110 having a modified pulse width (PW2) with a second temporal profile after the DPSSL oscillator 102 to output a second beam 118 having a second energy, a second spatial profile (flat top shape, see FIG. 8) and the second temporal profile. A multi-stage amplifier 106 is configured to output an output beam 126 after beam energy amplifications and beam profile modifications. The multi-stage amplifier 106 may include at least a first stage 901 (see FIG. 9) configured to amplify and modify the second beam 118 to output a third beam 915 having a third energy and a third temporal profile; and a second stage 902 configured to amplify and modify the third beam 915 to output a fourth beam 941 having a fourth energy and a fourth temporal profile, wherein the fourth beam 941 substantially maintains the pulse width (PW1) or the modified pulse width (PW2) within the defined tolerance.

The apparatus 100 may also include first and second optical isolators 114, 120 and a first pair of waveplate 116 and first polarizer 115, and a second pair of Pockels cell 104 and second polarizer 117, a beam delivery device 122, and a laser peening cell 124. The optical isolator 120 may pass a modified and amplified beam 126 from the amplifier 106 to the beam delivery device 122, which may deliver the modified and amplified beam 126 to a laser peening cell 124. The wave plate 116 may be a half wave plate or a quarter wave plate, depending on the application.

The first pair of wave plate 116 and first polarizer 115 may be disposed at an output of the DPSSL oscillator 102, wherein the first pair of wave plate 116 and first polarizer 115 may be configured to rotate a polarization angle of the first beam 108 by an amount to attenuate the first energy of the first beam 108 to produce an attenuated first beam 109 not to exceed a defined first energy level that is safe for the system. The attenuated first beam 109 may thus retain most of the beam characteristics, such as the pulse width (PW1), a beam diameter d1, and a temporal profile of the first beam 108.

The second pair of Pockels cell 104 and second polarizer 117 may be disposed between the first pair of wave plate 116 and first polarizer 115, and the optical filter 112, wherein the second pair of Pockels cell 104 and second polarizer 117 may be configured to perform nanosecond-duration switching on the first beam 108 or the attenuated first beam 109 from the first polarizer 115, by allowing or preventing the first beam 108 or the first attenuated beam 109 from exiting the Pockels cell 104, wherein an exit beam is the modified first beam having the modified pulse width (PW2) with the second temporal profile.

In an implementation, the Pockels cell 104 may include a crystal material containing one of: barium borate (BBO) or potassium dideuterium phosphate (KD*P). In a case where the Pockels cell 104 includes a crystal material containing KD*P, the Pockels cell 104 may further be configured to perform pulse slicing (see FIG. 6) of a leading edge portion 656 (alternately pulse slicing both the leading edge 656 and the trailing edge 660) of the first beam 108 or the first attenuated beam 109 to output the modified first beam 110 having the modified pulse width 662 (PW2, see FIG. 6) of less than 12 nanosecond (typically 5-12 nanoseconds) with the second temporal profile.

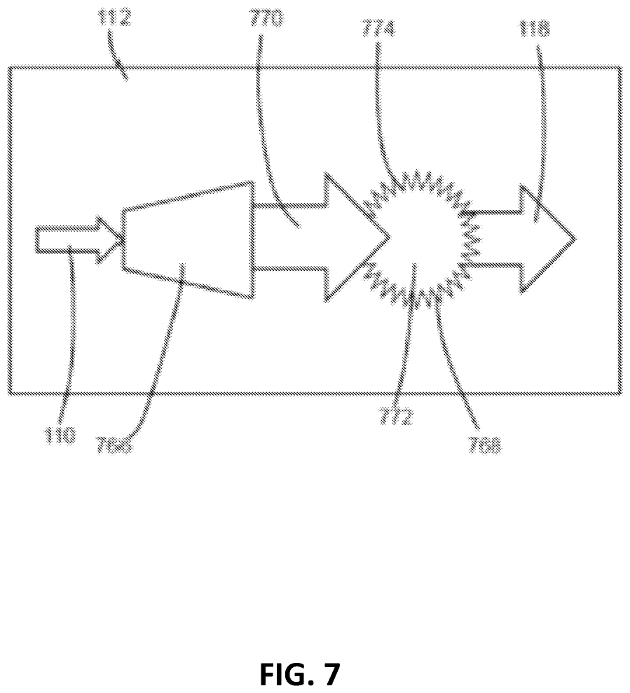

In an implementation (see FIGS. 7-8), the first beam 108 output from the DPSSL oscillator 102 may have a first diameter d1 and wings sections (878), and the optical filter 112 may include: a beam expander 766 configured to expand the first beam 108 or the modified first beam 110 to a diameter d2, which is greater than the first diameter d1; and an apodizer 768 configured to receive the expanded first beam or the expanded modified first beam 770 from the beam expander 766, to remove the wing portions 878 to output the second beam 118 having a second spatial profile with a flat top 881 without the wing portions 878.

In an implementation, the multi-stage amplifier 106 may further include: a third stage 903 configured to amplify and modify the fourth beam 941 to output a fifth beam 959 having a fifth energy and a fifth temporal profile; and a fourth stage 904 configured to amplify and modify the fifth beam 959 to output a sixth beam or an output beam 126 having a sixth energy and a sixth temporal profile.

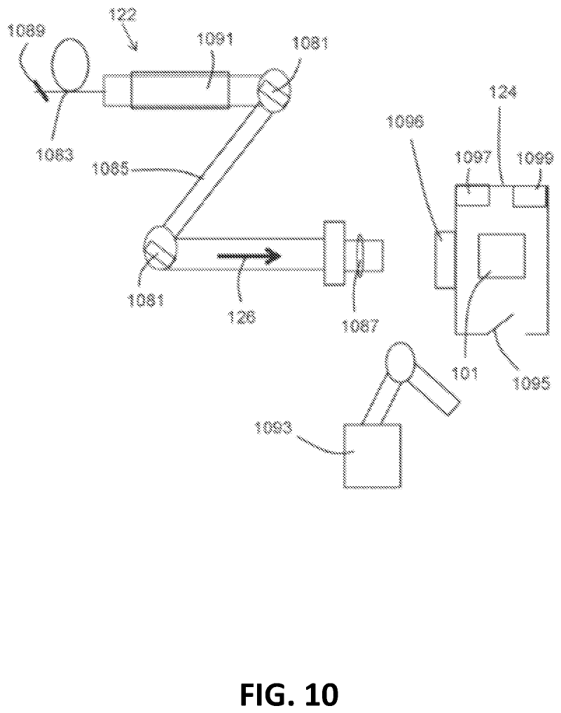

In an implementation (see FIG. 10), the output beam 126 from the multi-stage amplifier 106 to a beam delivery device 122 may have near field values and measurements, and the laser beam delivery device 122 may include a vacuum relay imaging module (VRIM) 1091 configured to maintain the near field values and the measurements of the output beam 126 and to deliver the output beam 126 to the target part 101.

The apparatus 100 may include a feedback mechanism to monitor beam characteristics for beam stability (such as pulse widths, beam diameter, energy level, etc.) and to adjust certain beam settings (such as current setting, wave plate and polarizer rotation angle, Pockels cell bias voltage, amplifier gain, etc.) in order to ensure that the pulsed laser beam operates within a prescribed performance matrix. In an implementation, a beam detector 130 (including a photodetector and a high-speed oscilloscope 131) may be coupled to one or a combination of the first polarizer 115, the second polarizer 117, and a beam delivery device 122 disposed after the multi-stage amplifier 106, for monitoring one or a combination of: a beam pulse width, a beam diameter, and an energy level.

The beam detector 130 may generate an error signal 128 from the monitoring to be sent back as a feedback signal to the controller 140. If a magnitude of the error signal 128 exceeds a defined error range, the error signal 128 may cause the controller 140 to perform one or a combination of the following: configure the current source 142 to output a correction current 143 to tune the DPSSL oscillator 102 to counter the pulse width error signal until the pulse width (PW1) stays within the defined tolerance according to the current setting selection; configure the first pair of the wave plate 116 and the first polarizer 115 to rotate a correction polarization angle 144 to the first beam 108 by an amount to increase or decrease an attenuation of the first energy of the first beam 108 to stay within the defined first energy level; configure the Pockels cell 104 to switch on or off, or to adjust the modified pulse width (PW2) by an amount 145 to stay within the defined tolerance; and configure the multi-stage amplifier 106 with a correction gain signal 146 to adjust one or a combination of the beam energy amplifications and the beam profile modifications to stay within a defined output energy level and a defined beam profile.

In an implementation, the apparatus 100 may include a first isolator 114 disposed between the DPSSL oscillator 102 and the wave plate 116, and a second isolator 120 disposed between the multi-stage amplifier 106 and the beam delivery device 122, wherein the first isolator 114 and the second isolator 120 may prevent beam reflections in an opposite direction.

FIG. 1B illustrates an example method 160 of pulsed laser beam generation and adjustment for laser peening a target part by an apparatus 100. The method 160 includes using a controller 140 which may be a universal controller having at least a processor (PROC 148) which executes codes of an algorithm stored in a memory (MEM 147), to perform controlling of one or a combination of: the current source 142, the wave plate 116, the Pockels cell 104, and the multi-stage amplifiers 106 (see FIG. 1A) to perform the previously described functions in the apparatus 100.

The method 160 may include step 162 in which a DPSSL oscillator 102 in the apparatus 100 generates a pulsed laser beam having predefined beam characteristics corresponding to a current setting selection (e.g., from a look up table LUT 141) stored in a controller 140. In response to the current setting selection, the controller 140 may control a current source 142 to output a current 143 (or a correction current) to tune the DPSSL oscillator 102 to generate a first beam 108 having a pulse width (PW1) within a defined tolerance, a first energy, a first spatial profile, and a first temporal profile.

In step 170, an optical filter 112 may perform modifying a received modified first beam 110 having a modified pulse width (PW2) with a second temporal profile after the DPSSL oscillator 102 to output a second beam 118 having a second energy, a second spatial profile (flat top shape, see FIG. 8), and the second temporal profile.

In step 172, a multi-stage amplifier 106 may perform amplifying a beam energy and modifying a beam profile to output an output beam 126, the amplifying and the modifying including: amplifying and modifying the second beam 118 by a first stage 901, to output a third beam 915 having a third energy and a third temporal profile; and amplifying and modifying the third beam 915, by a second stage 902 to output a fourth beam 941 (which may be an output beam 126) having a fourth energy and a fourth temporal profile, wherein the fourth beam 941 substantially maintains the pulse width (PW1) or the modified pulse width (PW2) within the defined tolerance. In an implementation, the step of 172 may include further energy amplification and beam temporal profile modification by additional amplifier stages. For example, the multi-stage amplifier 106 may further include: a third stage 903 configured to amplify and modify the fourth beam 941 to output a fifth beam 959 having a fifth energy and a fifth temporal profile; and a fourth stage 904 configured to amplify and modify the fifth beam 959 to output a sixth beam as the output beam 126 having a sixth energy and a sixth temporal profile.

In step 174, the output beam 126 may be delivered by a beam delivery device 122 to a target 101 for performing laser peening. In practice (see FIG. 10), the output beam 126 from the multi-stage amplifier 106 to a beam delivery device 122 may have near field values and measurements, and the laser beam delivery device 122 may include a VRIM 1091 configured to maintain the near field values and the measurements of the output beam 126 and to deliver the output beam 126 to the target part 101.

In an implementation, the method 160 may include an additional step 164, in which a first pair of wave plate 116 and first polarizer 115 may be disposed at an output of the DPSSL oscillator 102, wherein the first pair of wave plate 116 and first polarizer 115 may be configured to rotate a polarization angle to the first beam 108 by an amount to attenuate the first energy of the first beam 108 to produce an attenuated first beam 109 not to exceed a defined first energy level that is safe for the system. The attenuated first beam 109 may thus retain most of the beam characteristics such as the pulse width (PW1), a beam diameter d1, and a temporal profile of the first beam 108.

In an implementation, the method 160 may include an additional step 166, in which a second pair of Pockels cell 104 and second polarizer 117 may be disposed between the first pair of wave plate 116 and first polarizer 115, and the optical filter 112, wherein the second pair of Pockels cell 104 and second polarizer 117 may be configured to perform nanosecond-duration switching on the first beam 108 or the attenuated first beam 109 from the first polarizer 115, by allowing or preventing the first beam 108 or the first attenuated beam 109 from exiting the Pockels cell 104, wherein an exit beam is the modified first beam having the modified pulse width (PW2) with the second temporal profile.

In an implementation, the method 160 may include an additional step 168 of performing pulse slicing of a leading edge of the first attenuated beam 109. The Pockels cell 104 may comprise a crystal material containing one of: BBO or KD*P. In a case where the Pockels cell 104 includes the crystal material containing KD*P, the Pockels cell 104 may further be configured to perform pulse slicing (see FIG. 6) of at least a wing portion 678 of a leading edge portion 656 (alternately pulse slicing both the leading edge 656 and the trailing edge 660) of the first beam 108 or the first attenuated beam 109 to output the modified first beam 110 having the modified pulse width 662 (PW2, see FIG. 6) of less than 12 nanoseconds (typically 5-12 nanoseconds) with the second temporal profile.

In an implementation, the method 160 may include performing a feedback mechanism in one or a combination of steps 165, 169, and 175 to monitor beam characteristics for beam stability (such as pulse widths, beam diameter, energy level, etc.) and to adjust certain beam settings (such as current setting, wave plate and polarizer rotation angle, Pockels cell bias voltage, amplifier gain, etc.) in order to ensure that the pulsed laser beam operates within a prescribed performance matrix. In an implementation, a beam detector 130 (including a photodetector and a high-speed oscilloscope 131) may be coupled to one or a combination of the first polarizer 115, the second polarizer 117, and a beam delivery device 122 disposed after the multi-stage amplifier 106, for monitoring one or a combination of: a beam pulse width, a beam diameter, and an energy level.

The beam detector 130 may generate an error signal 128 from the monitoring to be sent back as a feedback signal to the controller 140. If a magnitude of the error signal 128 exceeds a defined error range, the error signal 128 may cause the controller 140 to perform one or a combination of the following: configure the current source 142 to output a correction current 143 to tune the DPSSL oscillator 102 to counter the pulse width error signal until the pulse width (PW1) stays within the defined tolerance according to the current setting selection; configure the first pair of the wave plate and the first polarizer to rotate a correction polarization angle 144 to the first beam by an amount to increase or decrease an attenuation of the first energy of the first beam to stay within the defined first energy level; configure the Pockels cell 104 to switch on or off, or to adjust the modified pulse width (PW2) by an amount 145 to stay within the defined tolerance; and configure the multi-stage amplifier 106 with a correction gain signal 146 to adjust one or a combination of the beam energy amplifications and the beam profile modifications to stay within a defined output energy level and a defined beam profile.

The method 160 may include disposing a first isolator 114 between the DPSSL oscillator 102 and the wave plate 116 and disposing a second isolator 120 between the multi-stage amplifier 106 and the beam delivery device 122 for preventing beam reflections in an opposite direction.

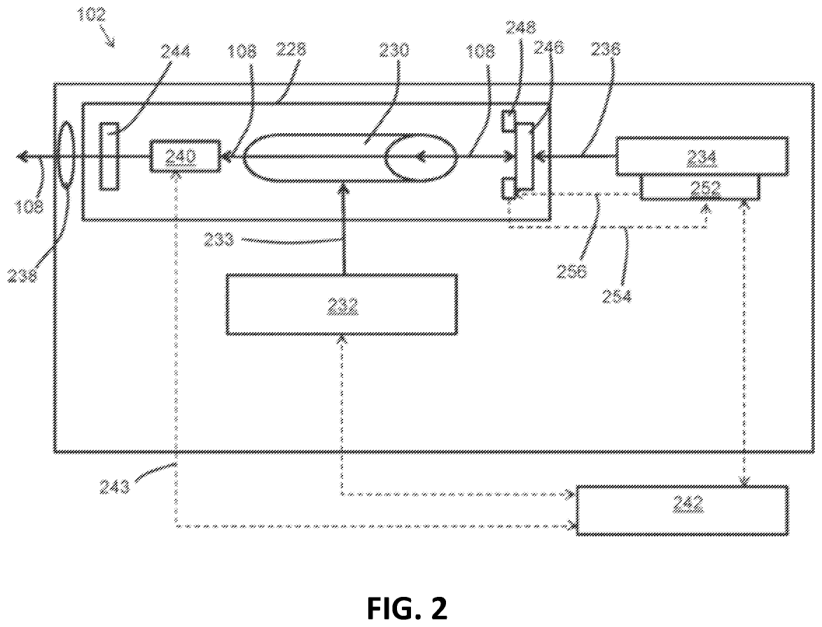

With reference to FIG. 2, a schematic of a DPSSL oscillator 102 is illustrated. The DPSSL oscillator 102 may include an optical cavity 228, a gain medium 230 within the optical cavity 228, and a laser diode array 232 to pump the gain medium 230 with light and energy 233 to produce a pulsed laser first beam 108. The oscillator 102 may further include an injection seeder 234 configured to output a seed laser beam 236 into the cavity 228 to help stabilize the first beam 108, and an iris/limiting aperture 238.

The gain medium 230 may be a 2 mm diameter (Nd:YLF) laser rod and may be a solid gain medium which may be optically pumped by one or more laser diodes (i.e., diode arrays) 232. The gain medium 230 may be of a single crystal or glass material and may be doped with trivalent rare earth ions or transitional metal ions. In one aspect, the laser rod 230 used in oscillator 102 may be doped with neodymium (Nd³⁺). The gain medium 230 may be a synthetic yttrium aluminum garnet crystal (Y₃Al₅O₁₂) otherwise known as “YAG,” doped with neodymium (Nd:YAG). In another aspect, the gain medium 230 may be a synthetic yttrium lithium fluoride (YLiF₄) crystal, or “YLF,” doped with neodymium (Nd:YLF). The first beam 108 produced by a (Nd:YLF) laser rod 230 may have a wavelength of 1053 nm. YLF crystals may produce a laser beam with a better beam quality, have a longer lifetime, and allow extraction of longer beam pulse widths, which may allow for a smaller design of the apparatus 100. Both YAG and YLF crystals may be grown using known processes, such as the Czochralski process. Crystals may be grown to various geometries and configurations so as to vary factors of the gain media, such as gain and energy storage.

The laser diode array 232 may pump the gain medium 230 with light energy 233 for amplification by the gain medium 230. In one aspect, the laser diode array 232 includes an array of nine diode bars pumping the gain medium 230 to produce a 10 mJ (milli Joule) laser output 108. As an example, the laser diode array 232 may have a QCW (quasi continuous wave) power output of about 6000 W and operate at a current of about 15 A with an electrical-optical efficiency of about 57%. As an example, the diode array 232 may have an operating voltage of about 60 V. In one aspect, the diode array 232 emits electromagnetic radiation at a wavelength of about 805.5±2 nm. In another aspect, the diode array 232 emits electromagnetic radiation at a wavelength between about 750 nm to about 900 nm. A universal controller (UCC) 242 may be used to control the pumping of the gain medium 230 by the laser diodes 232. Specifically, the UCC 242 may control the timing of the laser diodes 232 so that the laser diodes 232 only pump the gain medium 230 as the first beam 108 passes through the gain medium 230 to optimize the gain and amplification of the first beam 108.

The oscillator 102 may further include a modulator 240 (i.e., a Q-switch) configured to produce a pulsed laser beam 108. In one aspect, the Q-switch 240 is used to produce a first beam 108 with a pulse width in the nanosecond range. The UCC 242 for the apparatus 100 may feed a trigger signal 243 to the Q-switch 240 to control the generation and a frequency of generation of the first beam 108. In one aspect, a repetition rate of about 20 Hz is used for pulse generation for laser peening applications. In another aspect, a repetition rate of between about 25 Hz and about 30 Hz is used for pulse generation. In another aspect, a repetition rate of about 50 Hz or higher is used for pulse generation. The repetition rate may be varied and user-selected such that repetition rates slower than a 20 Hz base rate may be used. For example, repetition rates of 20 Hz, 19 Hz, 18 Hz, 17 Hz, 16 Hz, 15 Hz, 14 Hz, 13 Hz, 12 Hz, 11 Hz, 10 Hz, 9 Hz, 8 Hz, 7 Hz, 6 Hz, 5 Hz, 4 Hz, 3 Hz, 2 Hz, and 1 Hz are contemplated. For the Q-switched optical cavity 228 on the oscillator 102 as described herein, repetition rates of, for example, 20 Hz, 10 Hz, 6.67 Hz, 5 Hz, 4 Hz, 3.33 Hz, 2.857 Hz, 2.5 Hz, 2.22 Hz, 2 Hz, and 1 Hz are contemplated. These example frequencies are created by selecting every pulse to achieve a frequency of 20 Hz, selecting every second pulse to achieve a frequency of 10 Hz, selecting every third pulse to achieve a frequency of 6.67 Hz, and so on.

As shown in FIG. 2, the optical cavity 228 may further include a first mirror 244 and a second mirror 246. The mirrors 244 and 246 reflect the coherent light emitted by the gain medium 230 within the optical cavity 228 to amplify the beam 108 as the beam 108 is output from the oscillator 102. A piezo electric translator 248 may be mounted to the second mirror 246.

The injection seeder 234 may be configured to output a seed laser beam 236 into the optical cavity 228 to help stabilize the first beam 108. The injection seeder 234 may be a single longitudinal mode (SLM) fiber laser that injects a seed laser beam 236 into the optical cavity 228 to produce a first beam 108 of a single longitudinal mode within the optical cavity 228.

The injection seeder 234 may include a seeder controller 252. The seeder controller 252 may interface with the UCC controller 242 of the apparatus 100 for controlling a seeder reset function. The seeder controller 252 may also be used to control the position of the PZT 248 so as to control a position of the second mirror 246. A feedback line 254 connects the PZT 248 to the seeder controller 252. An output line 256 connects the seeder controller 252 to the PZT 248.

In use, a seeder reset signal and a PZT control signal may be sent from the seeder controller 252 via the output line 256 to control a position of the PZT 248. The PZT 248 outputs a voltage to the feedback line 254 based on its position, which corresponds to both its current position and the current position of the second mirror 246. The seeder controller 252 may adjust a position of the second mirror 246 to control a phase shift of the first beam 108 within the optical cavity 228 and maintain a desired phase of the first beam 108 with respect to the single longitudinal mode (SLM). In other words, the seeder controller 252 may control a position of the PZT 248 and the second mirror 246 to maintain the first beam 108 in an SLM.

The PZT 248 has a starting position. The starting position of the PZT 248 occurs during the startup of the apparatus 100 and after a seeder reset signal has been sent from the seeder controller 252 to the PZT 248. As the oscillator 102 produces and outputs the beam 108, the PZT continually adjusts and moves to new positions away from its starting position to maintain subsequent beams 108 in the SLM. The seeder controller 252 may store a reference voltage corresponding to a position of the PZT 248 that may produce an SLM first beam 108. The reference voltage is compared to the voltage from the PZT 248 that corresponds to the current position of the PZT 248 relative to the starting position. If the difference in the compared values falls outside of a predetermined range, the seeder controller 252 may send PZT control signals via the output line 256 to adjust the position of the PZT 248 and the second mirror 246. In time, the PZT 248 will reach a movement limit, after which, the PZT 248 may no longer move to adjust the position of the second mirror 246. At this time, the seeder controller 252 performs a “seeder reset” to return the PZT 248 to its starting position. The seeder controller 252 sends a reset signal via the output line 256 to the PZT 248, and upon receiving the seeder reset signal, the PZT 248 moves from its current position to the starting position.

The seeder controller 252 may also be used to control when a reset of the PZT 248 is performed. One issue with seeders may be that a reset of the PZT 248 may occur automatically and could occur during full-system lasing. A seeder's manual controls may be modified and integrated into the seeder controller 252 and the UCC controller 242 in order to predict a need for seeder resets and perform seeder resets at a time when it is appropriate to do so.

As shown in FIG. 2, the oscillator 102 may further include an iris/limiting aperture 238. The iris 238 may include an aperture opening to pass the laser beam 108 before it is output from oscillator 102. The size of the aperture on the iris 238 may regulate the amount of the beam 108 output from the oscillator 102. Passing the beam 108 through the iris 238 is used to produce a beam in the TEM₀₀ single transverse mode.

As used herein, a “single transverse mode” (STM) means the oscillator 102 is operating on a single transverse resonator mode, generally a Gaussian mode, such that the quality of laser beam 108 is diffraction-limited such that the beam 108 may be focused to a very small spot. Here, the transverse resonator mode would be transverse electromagnetic mode (TEM) mode, such that there is neither a magnetic field, nor an electric field in a direction of beam propagation. A “single longitudinal mode” (SLM) means a longitudinal beam of a single frequency and a single wavelength. A major source of noise in laser systems may be fluctuations of a pump source 232, changes in length of the optical cavity 228, or alignment of the optical cavity 228. Limiting the beam 108 output from oscillator 102 to STM and SLM may eliminate noise in the beam 108. Thus, the oscillator 102 may be operable to output a pulsed laser beam 108 in both an STM and SLM.

Beam uniformity is a beam-profile measurement and represents the normalized RMS (root mean square) deviation of the energy density from its average, over the central 90% or more of the beam 108. Data outside of the central 90% is not included in the RMS calculation. In one aspect, the beam uniformity for the pulsed laser beam 108 output from the oscillator 102 is less than about 0.2.

Beam quality is given by an M² value and referred to as a beam quality factor. The M² value is used to quantify a degree of variation between an actual beam 108 and an ideal beam. For a single transverse mode, TEM₀₀ Gaussian laser beam, M² is exactly 1.0. In one aspect, the oscillator 102 outputs a beam 108 with a M² value of about 1.2 or less. In another aspect, the oscillator 102 outputs a beam 108 with a M² value of less than about 1.3. In another aspect, the oscillator 102 outputs a beam 108 with a M² value of less than about 1.5. An SLM beam 108 may have a spectral width of about 1 pm. The modifier “substantial” is used at various times herein. Whether explicit or otherwise, the terms “single transverse mode” and “single longitudinal mode” should be read as “substantially single transverse mode” and “substantially single longitudinal mode,” with reference to the M2 description. Such a deviation from the ideal will be readily understandable to persons having ordinary skill in the art.

In addition to an output beam in STM and in SLM, the pulsed laser beam 108 output from the oscillator 102 may have a first energy of about 10 mJ to about 20 mJ, have a first beam diameter up to about 4 mm in diameter, have a first temporal profile (e.g., Gaussian-shaped), and have a first spatial profile (e.g., Gaussian-shaped).

With reference to FIG. 1A, the modulator 104 may receive the pulsed laser beam 108 from the oscillator 102. The modulator 104 may be a pulse slicer used to sharpen either or both of the leading edge and the trailing edge of the pulsed laser beam 108 to modify the temporal profile of the pulsed laser beam 108, and output a modified beam 110 with a second energy, a first diameter, a second temporal profile, and a first spatial profile.

In one aspect, the pulse slicer 104 is an SBS cell used to vary a temporal profile of the laser beam 108. In another aspect, the pulse slicer 104 is a Pockels cell used to vary a temporal profile of the laser beam 108.

The modulator 104 may include a crystal material such as BBO or KD*P through which the pulsed laser beam 108 passes. In one aspect, the pulse slicer 104 includes a BBO material to provide faster pulse slicing of the beam 108. In one aspect, the pulse slicer 104 modifies a leading edge of the laser pulse 108. In another aspect, the pulse slicer 104 modifies both a leading edge and a tailing edge of the laser pulse 108. The pulsed laser beam 108 may be sliced and output as modified beam 110 with a rise time of less than about 5 ns. In one aspect, rise time of the modified beam 110 is less than 3 ns. In another aspect, the rise time of the modified beam 110 is less than about 2 ns. In one aspect, the pulse width of the beam 108 is adjusted to between about 5 ns and 16 ns for output as the modified beam 110. In another aspect, the pulse width of the beam 108 is adjusted to between about 8 ns and 16 ns for output as the modified beam 110. In another aspect, the pulse width of the modified beam 110 is less than or equal to about 5 ns. A short rise time provides a laser beam that produces better laser shock peening results.

FIG. 3 illustrates an example temporal profile of the first beam 108 as a normal output from the DPSSL oscillator 102. The first beam 108 shows a Gaussian shape temporal profile, which may be output from the oscillator 102 between a seeder reset operation, with no substantial effect to the first beam 108.

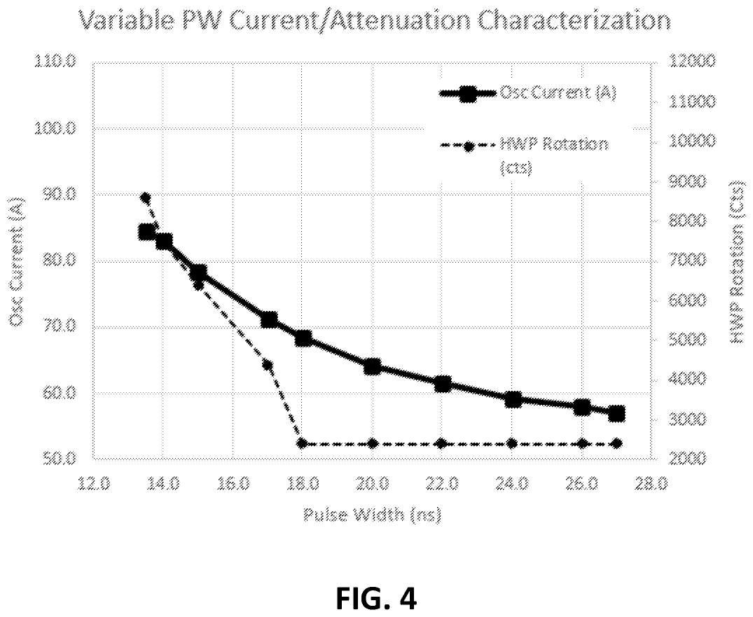

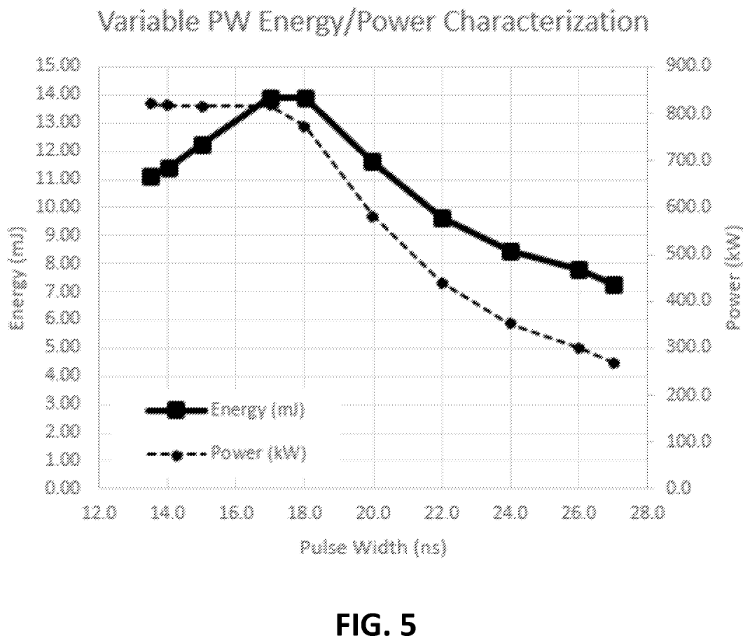

FIG. 4 illustrates the current settings and the wave plate 116 rotation settings over a range of different pulse widths. FIG. 5 illustrates a measured plot showing the energy and power (before amplifications) relationship over a range of different pulse widths. The plots in FIGS. 4 and 5 may be stored in the look up table (LUT 141), which may be used for programmable settings and may serve as reference data to compare with the detected measurements by the beam detector 130 to generate error signals 128 for the feedback mechanism.

For example, FIG. 4 shows a more rapid change of pulse width adjustment between a current range from 85 to about 68 amperes. Below 68 amperes, the change is more moderate. FIG. 5 shows that the first beam 108 may peak the energy at pulse widths around 17-18 nanoseconds. In FIGS. 4 and 5, the wave plate 116 rotations may exhibit a relatively linear region with the least changes in attenuation over the pulse widths range between 13-18 nanoseconds, and the energy attenuation by the wave plate 116 is more rapid beyond the 18 nanoseconds pulse widths.

With reference to FIG. 6, a temporal profile 600 of the example modified beam 110 is illustrated. As described above, a temporal profile of the pulsed laser first beam 108 from the oscillator 102 may be substantially Gaussian in appearance, as illustrated. As the first beam 108 is modified to the modified first beam 110 by the KD*P crystal containing Pockels cell 104, the leading edge 656 may be sliced off by the KD*P crystal containing Pockels cell 104 to create a sharper leading edge 658 of the laser pulse. The sharp leading edge 658 of the laser pulse may provide a faster rise time for the modified first beam 110. The trailing edge 660 of the laser pulse may also be sliced off by the KD*P crystal containing Pockels cell 104 to vary a pulse width 662 of the modified first beam 110.

With reference to FIG. 1A, the modified first beam 110 may be output from the KD*P crystal containing Pockels cell 104 and pass through the optical isolator 120. In one aspect, the optical isolator 120 is a Faraday isolator that transmits the modified first beam 110 in a forward direction while blocking light in opposite directions, for example, reflected laser energy from optical surfaces of components in the apparatus 100 or from the target part 101. The optical isolator 120 may be used to protect the oscillator 102 and the KD*P crystal containing Pockels cell 104 from interactions of the modified beam 110 with other components in the apparatus 100, to limit and prevent back reflections—that is, prevent and limit light reflected from the other components from passing backward through the optical isolator 120 and damaging the oscillator 102 and the KD*P crystal containing Pockels cell 104. In one aspect, the Faraday isolator 120 is configured to pass a modified first beam 110 having a first beam diameter d1 of up to about 4 mm.

The waveplate 116 may be, for example, a half-wave plate (λ/2 plate) used to rotate the polarization of linearly polarized laser pulses, for example, the first beam 108. As a laser pulse interacts with optical components of the apparatus 100, the polarization state of the laser pulse may change. The waveplate 116 may be used to fine tune the apparatus 100 by rotating through the first polarizer 115, the polarization of the first beam 108 for optimum energy transmission of the pulse through the apparatus 100. The rotation through the first pair of wave plate 116 and the first polarizer 115 may output an attenuated first beam 109, which has the optimum energy level for amplification. In another implementation, additional wave plates may be added to the apparatus 100 to optimize the transmission of a laser pulse through the optical components in the apparatus 100. Additional wave plates used may be the same as the waveplate 116 shown in FIG. 1A, or alternatively, they may be different. For example, such a different waveplate may be a quarter-waveplate (λ/4 plate).

The optical filter 112 may receive the modified first beam 110 from the second polarizer 117, which is disposed after the waveplate 116, and the optical filter 112 may further modify the modified first beam 110 from having a second energy, a second temporal profile and a first spatial profile, to a second beam 118 having a second energy, a second temporal profile, and a second spatial profile, and output the second beam 118.

With reference to FIG. 7, a schematic diagram of an example optical filter 112 is illustrated and may include a beam expander 766 and a beam shaping element 768. The beam expander 766 may be used to increase a diameter of the modified first beam 110 greater than the first diameter d1 of the first beam 108 produced by the oscillator. By increasing the diameter d1 of the modified first beam 110 with the beam expander 766, the expanded modified first beam 770 may overfill an aperture 772 on the beam shaping element 768. In one aspect, the beam shaping element 768 is an apodizer. An apodizer 768 may include an aperture 772 with a grit blasted or serrated edge 774. By expanding the modified first beam 110 with the beam expander 766 and overfilling the apodizer 768 with the expanded modified first beam 770, wing portions of the expanded modified first beam 770 may be removed to further modify the modified first beam 110 with the first spatial profile to the second beam 118 having a second spatial profile with a more flat-top, top-hat shaped appearance. Other beam shaping devices may be used for beam shaping element 768. In one aspect, a pi shaper (πShaper®), manufactured by AdlOptica Optical Systems GmbH of Berlin, Germany, is used as the beam shaping element 768 to produce a flat-top (or pi-shaped) second beam 118.

With reference to FIG. 8, an example spatial profile 800 of the second beam 118 is illustrated. Both the pulsed laser beam 108 and the modified first beam 110 shown in FIG. 1A may have a first spatial profile that appears substantially Gaussian, for example, as illustrated in FIG. 8. A beam shaping element may be used to create a substantially top-hat shaped, flat-top beam from the beam center portion 876. After removing the wing sections 878, the rounded portion 880 of the substantially top-hat shaped, flat-top beam may continue to flatten, as approximated by the dashed line 881, as the second beam 118 with the flat-top center portion 876 passes through an amplifier.

With reference to FIG. 1A, the second beam 118 having a second energy, a second temporal profile, and a second spatial profile may be output from the optical filter 112 and input into the multi-stage amplifier 106 for amplification of the second beam 118. The amplifier 106 may output an output beam 126 which has been amplified and modified. In one aspect, the pulsed laser first beam 108 output from the oscillator 102 has a first energy, a first beam diameter d1, a first temporal profile, and a first spatial profile, while the modified and amplified output beam 126 output from the multi-stage amplifier 106 has an energy greater than the first energy, a beam diameter d2 greater than the first beam diameter d1, a temporal profile different than the first temporal profile, and a spatial profile different than the first spatial profile.

With reference to FIG. 9, an example multi-stage amplifier 106 is illustrated. As illustrated in FIG. 9, the amplifier 106 has four amplification stages 901, 902, 903, and 904. As shown here, the second beam 118 may enter the first amplifier stage 901, and a modified and amplified output beam 126 may be output from the fourth amplifier stage 904.

The second beam 118 may be input into the input 905 on the first amplifier stage 901 and passed through the optical isolator 907. From the optical isolator 907, the second beam 118 may pass further through a VRIM 909 that focuses the second beam 118, and then re-collimates the second beam 118 to an increased diameter d3, before outputting a collimated beam 911 to an amplifier module 913. The amplifier module 913 may amplify the collimated beam 911 and output an amplified third beam 915 to a first amplifier stage output 917.

An optical isolator 907 may function similarly to the optical isolator 114 or 120 described above. The optical isolator 907 may be a Faraday isolator that transmits the second beam 118 in a forward direction of travel while blocking backscattered light and other backward directed energy from the second beam 118. In one aspect, the optical isolator 907 is used to protect the previously described components of the apparatus 100 from backward directed energy from the second beam 118 after the second beam 118 passes through the optical isolator 907. The optical isolator 907 may provide for a passage of the second beam 118 with a beam diameter of up to about 8 mm.

The second beam 118 may pass through the isolator 907 and be input into the VRIM 909. The VRIM 909 may focus and re-collimate the second beam 118 and output the collimated beam 911. The VRIM 909 may include a first lens 921, a vacuum tube 923, and a second lens 925. The second beam 118 enters the VRIM 909 and passes through the first lens 921, which passes the second beam 118 through focus near the center of the inside of the vacuum tube 923. As the second beam 118 exits the vacuum tube 923, the second beam 118 is re-collimated by the second lens 925. The collimated beam 911 is output from the VRIM 909 with a decreased beam intensity and a third beam diameter d3 greater than the second beam diameter d2 of the pulsed laser second beam 118. The VRIM 909 relays the second beam 118 into a larger third diameter d3 collimated beam 911. The vacuum tube 923 is used to prevent the air breakdown of the second beam 118 at the point of focus. The air breakdown of the second beam 118 would result in a loss of beam quality and beam energy.

The VRIM 909 may preserve a spatial profile of the second beam 118, while increasing the size of the second beam 118 to optimally fill the gain medium 927 of the amplifier module 913. Optimally filling the gain medium 927 optimizes the amplification of the collimated beam 911 by the amplifier module 913.

The beam 911 enters into the gain medium 927 of the amplifier module 913. The amplifier module 913 includes the gain medium 927 and a pump source 929. The pump source optically pumps the beam 911 as it passes through the gain medium 927. The gain medium 927 may be a Nd:YLF crystal laser rod pumped by a laser diode array 929. As the beam 911 passes through the rod 927, the beam 911 is amplified and is output as an amplified third beam 915. In one aspect, the laser rod 927 is about 5 mm in diameter. In another aspect, the laser rod 927 is about 4-6 mm in diameter. In another aspect, the laser rod 927 is about 3-7 mm in diameter. The gain medium 927 may have a fill factor of about 80%—that is, about 80% of the gain medium area will be filled by the beam 911. Generally, a gain medium with a larger fill factor will have a higher gain, and more energy stored within the gain medium may be extracted. In one aspect, the rod 927 has a fill factor of 85%.

The first amplifier stage 901 with the amplifier module 913 may serve as a small preamplifier to amplify the energy of a second beam 118 input at the input 905 and output the amplified third beam 915 at the output 917. In the given example, the amplified beam 915 may have a third energy of about 40 mJ to 100 mJ, a third beam diameter d3 of about 4.5 mm, a third temporal profile, and a third spatial profile.

The amplified third beam 915 may be input into an input 931 on the second amplifier stage 902. The second amplifier stage 902 may be similar to the first amplifier stage 901 and include a VRIM 933, and an amplifier module 935 having a gain medium 937, and a pump source 939. An amplified beam 941 may be output from the amplifier module 935 to a second amplifier stage output 943.

The VRIM 933 may be similar in operation to the VRIM 909 and include lenses and a vacuum tube to focus the amplified beam 915, re-collimate the third beam 915, and output a collimated beam 945. The VRIM 933 prevents the breakdown of the amplified beam 915 and increases a diameter d3 of the amplified third beam 915 to increase the fill factor of the collimated beam 945 on the gain medium 937. Lenses of the VRIM 933 may be of a larger diameter than the lenses 921 and 923 in the VRIM 909 (i.e., a beam with a higher energy and larger beam diameter, for example the amplified beam 915, may utilize larger diameter lenses), and the lengths of a vacuum tube in the VRIM 933 may be longer than the tube 923 in the VRIM 909. Generally, the lens size for a VRIM and a length of a vacuum tube in a VRIM increase with an increase in the beam energy and beam diameter. The VRIM 933 may relay image the amplified beam 915 into the collimated beam 945 with a diameter to provide the gain medium 937 with a fill factor of about 80% to 85%.

The amplifier module 935, similar to the amplifier module 913 described above, may include a gain medium 937 and a pump source 939. The beam 945 may pass through the gain medium 937 as the gain medium 937 is pumped by pump source 939, so as to amplify the beam 945, before the beam 945 is output from the amplifier module 935 as the amplified fourth beam 941. The gain medium 937 may be a Nd:YLF crystal laser rod pumped by a laser diode array 939. In one aspect, the laser rod 937 is about 9 mm in diameter. In another aspect, the laser rod 937 is about 8-10 mm in diameter. In another aspect, the laser rod 937 is about 7-11 mm in diameter. The second amplifier stage 902 with the amplifier module 935 may serve as a small preamplifier to amplify the energy of a third beam 915 input at the input 931 and output the amplified fourth beam 941 at the output 943. In the given example, the amplified fourth beam 941 may have a fourth energy of about 1 J, a fourth beam diameter d4 of about 8.1 mm, a fourth temporal profile, and a fourth spatial profile.

As shown in FIG. 9, the amplifier stages 901 and 902 may operate in the small signal gain regime, which may further sharpen the leading edge of the temporal profile of a beam through gain sharpening. The pulse width of the beam may also narrow as the beam passes through these amplifier stages.

The amplified fourth beam 941 may be input into an input 947 on the third amplifier stage 903. The third amplifier stage 903 may be similar to the previous amplifier stages 901 and 902 and include an optical isolator 949, a VRIM 951, and amplifier module 953 having a gain medium 955, and a pump source 957. An amplified fifth beam 959 may be output from the amplifier module 953 to a third amplifier stage output 961.

The optical isolator 949 may be similar in operation to the optical isolator 907 described above. In one aspect, the optical isolator 949 is configured to provide passage for the amplified fourth beam 941 having a diameter up to about 12 mm.

The VRIM 951 may be similar in operation to the VRIMs 909 and 933 described above, including lenses and a vacuum tube to focus the amplified fourth beam 941, re-collimate the amplified fourth beam 941, and output a collimated beam 963. The VRIM 951 prevents a breakdown of the amplified fourth beam 941 after the amplified fourth beam 941 is focused, and re-collimates the fourth beam 941 to increase the diameter of the amplified fourth beam 941 to increase the fill factor of the collimated beam 963 on the gain medium 955. The lenses of the VRIM 951 may be of a larger diameter than the lenses in the VRIMs 909 and 933, and the length of the vacuum tube in VRIM 951 may be longer than the vacuum tubes in the VRIMs 909 and 933. The VRIM 951 may relay image the amplified fourth beam 941 into the collimated beam 963 with a diameter to provide the gain medium 955 with a fill factor of about 80% to 85%.

The amplifier module 953, similar to the amplifier modules 913 and 935 described above, may include a gain medium 955 and a pump source 957. The collimated beam 963 may pass through the gain medium 955 as the gain medium 955 is pumped by the pump source 957 to amplify the beam 963, before the beam 963 is output from the amplifier module 953 as the amplified beam 959. The gain medium 955 may be a Nd:YLF crystal laser rod pumped by a laser diode array 957. In one aspect, the laser rod 955 is about 15 mm in diameter. In another aspect, the laser rod 955 is about 14-18 mm in diameter. In another aspect, the laser rod 955 is about 12-18 mm in diameter. The third amplifier stage 903 with the amplifier module 953 may serve as a small amplifier to amplify an energy of a beam input at the input 947 and output the fifth amplified beam 959 at the output 961. In the given example, the amplified beam 959 may have a fifth energy of about 4.3 J, a fifth beam diameter d5 of about 13.5 mm, a fifth temporal profile, and a fifth spatial profile.

The amplified fifth beam 959 may be input into an input 965 on the fourth amplifier stage 904. The fourth amplifier stage 904 may be similar to the previous amplifier stages 901, 902, and 903, and include a VRIM 967, a waveplate 969, and an amplifier module 971 having a gain medium 973 and a pump source 975. An amplified output beam 126 may be output from the amplifier module 971 to a fourth amplifier stage output 977.

The VRIM 967 may be similar in operation to the VRIMs 909, 933, and 951 described above, including lenses and a vacuum tube to focus the amplified fifth beam 959, re-collimate the amplified fifth beam 959, and output a collimated beam 979. The VRIM 967 prevents the breakdown of the amplified fifth beam 959 and re-collimates the amplified fifth beam 959 to increase the diameter of the amplified fifth beam 959, so as to increase the fill factor of the output beam 979 on the gain medium 973. The lenses of the VRIM 967 may be of a larger diameter than lenses in the VRIMs 909, 933, and 951, and the length of the vacuum tube in VRIM 967 may be longer than the tubes in the VRIMs 909, 933, and 951. The VRIM 967 may relay image the amplified fifth beam 959 into the collimated beam 979 with a diameter to provide the gain medium 973 with a fill factor of about 80% to 85%.

The amplifier module 971, similar to the amplifier modules 913, 935, and 953 described above, may include a gain medium 973 and a pump source 975. The collimated beam 979 may pass through the gain medium 973 as the gain medium 973 is pumped by the pump source 975 to amplify the beam 979, which is output from the amplifier module 971 as the amplified output beam 126. The gain medium 973 may be a Nd:YLF crystal laser rod pumped by a laser diode array 975. In one aspect, the laser rod 973 is about 25 mm in diameter. The fourth amplifier stage 904 with the amplifier module 971 may serve as an amplifier to amplify an energy of a beam input at the input 965 and output the amplified output beam 126 at the output 977. In one aspect, the fourth amplifier stage 904 includes one amplifier module 971. In another aspect, the fourth amplifier stage 904 includes one or more amplifier modules 971. In the given example, the amplified output beam 126 may have a sixth energy of about 7 J to 13 J, a sixth beam diameter d6 of about 20 mm to 25 mm, a sixth temporal profile, and a sixth spatial profile. The amplified output beam 126 output from the amplifier 106 may be a modified and amplified beam.

Characteristics of a beam moving through the amplifier 106 may change due to the amplification of the beam. For example, as a beam is amplified, the beam diameter may be increased by the optical elements in the amplifier 106 to more efficiently fill each gain medium (e.g., laser rod), which may provide the most optimally amplified laser output from the gain media, while also fully utilizing the capabilities of certain components within the amplifier 106.

The beam diameter may increase as a beam passes through the amplifier 106 so as to match a gain medium size (e.g., rod diameter), for example, the rods 927, 937, 955, and 973 used in the respective amplifier stages 901, 902, 903, and 904. As the beam energy is increased throughout the amplifier 106, a risk of damage to the optical components within the amplifier 106 increases if the beam diameter remains too small. The power density on the gain media may be kept below the damage thresholds by increasing the beam size as the beam energy increases.

Other characteristics of beam moving through the amplifier 106 may change due to the amplification of the beam. For example, the leading edge of a beam's temporal profile may be sharpened as a beam is amplified.

As shown in FIG. 2, the UCC controller 242 may be used to control the timing of amplifier modules 913, 935, 953, and 971, as shown in FIG. 9. Specifically, the UCC controller 242 may control when the pump source in an amplifier module pumps the gain medium in the amplifier module to optimize the amplification of a beam passing through the gain medium. In this way, the amplification of a beam passing through an amplifier module may be controlled.

With reference to FIG. 1A, an optical isolator 120 may be used after the output beam 126 is output from the amplifier 106 to prevent the output beam 126 from interacting with the prior optical components of the apparatus 100 once the output beam 126 passes through the optical isolator 120. For example, once the output beam 126 passes through the optical isolator 120, the optical isolator 120 prevents backscattered light from the output beam 126 from interacting with any of the prior optical components from the oscillator 102 to the amplifier 106 in the apparatus 100. In one aspect, the optical isolator 120 is a Faraday isolator and may allow the passage of the beam 126 having a diameter up to about 35 mm.

Additional elements may be used with the apparatus 100 to deliver a modified and amplified laser output beam 126 to the target part 101 for laser peening applications. The output beam 126 may pass through the optical isolator 120 and to the beam delivery device 122 for delivery to a target part 101 alone, or a target part 101 contained in the peening cell 124.

As illustrated in FIG. 10, the laser beam delivery device 122 may include one or more mirrors 1081, one or more optical cables 1083, and a multi-axis articulating arm 1085. A laser beam delivery device 122 may include focusing optics 1087 to focus a larger sized output beam 126 into a smaller spot size of about 2-3 mm for use in laser peening applications. In one aspect, a focusing optic 1087 of laser beam delivery device 122 focuses and adjusts a spot size of the output beam 126 to between about 3 mm and 8 mm. The laser beam delivery device 122 may also include additional safety features such as a shutter 1089 to block the output beam 126 from entering the laser beam delivery device 122, unless the delivery device 122 is positioned to deliver the beam 126 to the target part 101 or peening cell 124. Additional VRIM assemblies 1091 may be used with the laser beam delivery device 122 to maintain near field values and measurements of the modified and amplified output beam 126 output from the amplifier 106. In one aspect, a VRIM 1091 is used to relay image the beam 126 to the target part 101.

The laser peening cell 124 may contain the target part 101 to be laser peened. A robotic handling system 1093 may be adapted to manipulate the laser beam delivery device 122 to change the position of the laser beam delivery device, and thus the position of the output beam 126 output from the delivery device 122 to the target part 101. A robotic handling system 1093 may also be used to introduce parts to and from the laser peening cell 124. The laser peening cell 124 may provide a light-tight environment to confine dangerous laser light from the output beam 126 within the laser peening cell 124. The laser peening cell 124 may be equipped with additional options like lighting, an air filtration system, and evacuation system for removing effluent and debris produced during laser peening, and an interface 1095 (i.e., entry/exit) for a robot 1093 to move parts into and out of the laser peening cell 124, as well as other safety systems. In one aspect, the laser peening cell 124 may be sized at dimensions of about 4.5 m×4.5 m×3.0 m (height) to allow a robot 1093 to manipulate larger target parts therein. A laser peening cell 124 may include a target isolation system 1096, for example, an optical isolator, to prevent laser energy backscattered from the target part 101 from entering into the delivery device 122 or other optical elements of the apparatus. In one aspect, the laser peening cell 124 may optionally include an opaque overlay applicator 1097 to apply an opaque overlay to the target part 101, and a transparent overlay applicator 1099 to apply a transparent overlay to the target part 101. An opaque overlay and a transparent overlay may be applied to the target part 101 such that the amplified and modified beam 126 contacts the opaque and transparent overlays on the target part 101 during the laser peening process.

In one aspect, the near-field values of the modified and amplified beam 126 include an energy of about 7 to 13 J, a pulse width of up to about 16 ns, an average power of 200 W, and a spot size of at least 3 mm. In this aspect, the modified and amplified beam 126 with these parameters is produced by the apparatus 100 at a repetition rate of 20 Hz.

In another aspect, the near-field values of the modified and amplified beam 126 include an energy of about 5 J to about 10 J, and average power of about 5 W to about 200 W, a beam uniformity of less than about 0.2 (20%), and a beam focused to a spot size of about 3 mm to about 8 mm. In this aspect, the oscillator 102 of the apparatus 100 may produce a beam with a beam quality of less than about 1.3 M2 out of the oscillator, and a beam having these parameters and the initial beam quality may be produced with a variable repetition rate between about 1 Hz and 20 Hz, for example, optionally variable “on the fly,” depending on a surface of the target part 101.

In another aspect, a working distance of about 5-10 m between the final focusing optic 1087 and the target part 101 is possible. A large working distance may adequately distance the optical components of the apparatus 100 from debris and effluent produced during the LSP processes.

Aspects described herein may use robotic controls, control systems, and instruction sets stored on a computer readable medium, that when executed, may perform exampled methods described herein. For example, a robot may be used for manipulating a target part and directing a pulsed laser beam to different locations on a target part. A robot may be used to move target parts in and out of a laser peening cell for laser peening. A robot may move parts in batches for efficient laser peening. Robots may interface with a control system to manipulate parts for laser peening—that is, a robot may control positioning of a part such that a part may be positioned to receive both a transparent overlay and a laser pulse for laser peening. A robot arm may reposition the same part for subsequent laser peening targets on the part. In one aspect, a robot repositions a part for subsequent laser peening targets at a rate of about 20 Hz. In another aspect, a robot has a position repeatability accuracy of less than about 0.2 mm. Additionally, a robot may be used to interact with a tool or sensor to generate feedback for a system adjustment or calibration. As shown in FIG. 10, a robot such as a robotic arm 1093 may be equipped with the components of the beam delivery device 122, such that the robot 1093 and the beam delivery device 122 may be repositioned relative to a stationary part 101, to deliver a laser pulse to the target part 101 for laser shock peening. In this way, a robot may either control the position of the target part 101 relative to the output beam 126 or control the position of the output beam 126 relative to the target part 101.

An apparatus for use in LSP processes may interface with one or more controllers for controlling functions of the apparatus. Controllers may either automatically make calibrations or adjustments, or there may be a user interface for a user to interface with the control of the apparatus. For automatic control, various sensors may be employed to collect various beam parameters as beams progress through the apparatus. Sensor readings may either be collected in real time or collected at intervals and used as feedback for apparatus control. For example, temperature measurements may be taken within the apparatus at regular intervals to ensure that the apparatus is working within specified temperature ranges. A pulse energy, pulse width, and spatial profile of one or more pulses may be measured and monitored, and when measured values fall outside of a user-selected range, a control system may adjust components of the apparatus so that measured values may fall within a user-selected range.

Data related to laser beam parameters may be taken from inside the apparatus and from a beam delivery path (e.g., as a fraction reflection from an optical component or leakage of energy through a mirror). Data may be taken periodically and cross-calibrated to target data to ensure that laser peening process conditions are within user-selected tolerances.

Beam position and spot sized may be determined with a camera positioned in the beam path with very tight tolerances. A camera may be used to capture a beam image, and parameters extracted from a beam image may be compared with ideal parameters. For example, if a beam position is not centered as indicated by an ideal position parameter, a mirror may be automatically adjusted to move a beam closer to the position defined by the ideal parameters. Adjusting a moving a beam may be done in small increments and it may take several measurements and adjustments until a beam is positioned as defined by ideal position parameters. A camera may also be used to measure a spot area and spot size. A controller may automatically adjust a lens to adjust a target lens to set a spot size.

While not exhaustive or limiting, a control system used with an apparatus for use in laser peening may be used to/for: configure and monitor an eDrive/oscillator (e.g. timing, pump current); configure and monitor timing generator; control and monitor laser safety; control and monitor laser output; control and monitor laser temperature (e.g. enclosure temperature, cooling water temperature, etc.); control output energy via adjustments to laser-head timings; control of overlay application; control and monitoring of final focusing lens; control and monitoring of final turning mirror; integration with an outside control system such as a robot; to store the configurations of components in the apparatus; store data collected by the apparatus for later processing; and to control access to the apparatus (e.g., limit apparatus access to authorized users).

While not exhaustive or limiting, sensor components of a control system used with an apparatus for laser peening may sense and monitor: pulse width, pulse energy, a beam spatial profile, diode voltage, pump current, enclosure temperature, cooling water temperature, laser safety systems, and the health of the apparatus.

A control system, as described herein, may be used to automatically adjust: laser head timings; final focusing-lens position; final tuning-mirror position; overlay application timing; cooling system operation; and data collection. A control system may automatically adjust the energy of an output laser beam. A control system may automatically adjust diode voltage. Diode current may be controlled automatically by an eDrive.

The method may further include repeatedly adjusting by an open loop or by a feedback loop mechanism, the parameters of the laser by adjusting the final focusing lens, adjusting the position of a mirror in a laser beam delivery device, and adjusting a pulse slicer, and re-measuring the spot size, the beam position, and the pulse width until the spot size, the beam position, and the pulse width are within a tolerance of the user-defined spot size, beam position, and pulse width.

Unless specifically stated to the contrary, the numerical parameters set forth in the specification, including the attached claims, are approximations that may vary depending on the desired properties sought to be obtained according to the example aspects. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

Furthermore, while the systems, methods, and apparatuses have been illustrated by describing example aspects, and while the example aspects have been described and illustrated in considerable detail, it is not the intention of the applicants to restrict, or in any way limit, the scope of the appended claims to such detail if such detail is not recited in the claims. It is, of course, not possible to describe every conceivable combination of components or methodologies for purposes of describing the systems, methods, and apparatuses. With the benefit of this application, additional advantages and modifications will readily appear to those skilled in the art. Therefore, the invention, in its broader aspects, is not limited to the specific details and illustrative example and example aspects shown and described. Accordingly, departures may be made from such details without departing from the spirit or scope of the general inventive concept. Thus, this application is intended to embrace alterations, modifications, and variations that fall within the scope of the appended claims. The preceding description is not meant to limit the scope of the invention. Rather, the scope of the invention is to be determined by the appended claims and their equivalents.

As used in the specification and the claims, the singular forms “a,” “an,” and “the” include the plural. Furthermore, to the extent that the term “or” is employed in the claims (e.g., A or B) it is intended to mean “A or B or both.” When the applicants intend to indicate “only A or B, but not both,” then the term “only A or B but not both” will be employed. Similarly, when the applicants intend to indicate “one and only one” of A, B, or C, the applicants will employ the phrase “one and only one.” Also, to the extent that the terms “in” or “into” are used in the specification or the claims, it is intended to additionally mean “on” or “onto.” To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. Finally, where the term “about” is used in conjunction with a number, it is intended to include ±10% of the number. In other words, “about 10” may mean from 9 to 11.

1. An apparatus for pulsed laser beam control, the apparatus comprising:
a diode-pumped solid-state laser (DPSSL) oscillator configured to generate and output a pulsed laser beam having predefined beam characteristics corresponding to a current setting selection of a controller, wherein the controller in response to the current setting selection controls a current source to output a current to tune the DPSSL oscillator to generate a first beam having a pulse width within a defined tolerance, a first energy, a first spatial profile, and a first temporal profile;
an optical filter configured to modify a received modified first beam having a modified pulse width (PW2) with a second temporal profile to output a second beam having a second energy, a second spatial profile, and the second temporal profile; and
a multi-stage amplifier configured to output an output beam after beam energy amplifications and beam profile modifications, the multi-stage amplifier comprising:
a first stage configured to amplify and modify the second beam to output a third beam having a third energy and a third temporal profile; and
a second stage configured to amplify and modify the third beam to output a fourth beam having a fourth energy and a fourth temporal profile, wherein the fourth beam substantially maintains the pulse width (PW1) or the modified pulse width (PW2) within the defined tolerance.

2. The apparatus of claim 1, further comprising a first pair of wave plate and first polarizer, disposed at an output of the DPSSL oscillator, wherein the first pair of wave plate and first polarizer is configured to rotate a polarization angle to the first beam by an amount to attenuate the first energy of the first beam to produce an attenuated first beam not to exceed a defined first energy level.

3. The apparatus of claim 2, further comprising a second pair of Pockels cell and second polarizer, disposed between the first pair of wave plate and first polarizer, and the optical filter, wherein the second pair of Pockels cell and second polarizer is configured to perform nanosecond-duration switching on the attenuated first beam from the first polarizer, by allowing or preventing the first attenuated beam from exiting the Pockels cell, wherein an exit beam is the modified first beam having the modified pulse width (PW2) with the second temporal profile.

4. The apparatus of claim 3, wherein the Pockels cell comprises a crystal material comprising one of: barium borate or potassium dideuterium phosphate.

5. The apparatus of claim 4, wherein the Pockels cell comprises the crystal material comprising potassium dideuterium phosphate, and wherein the Pockels cell is further configured to perform pulse slicing of a leading edge of the first beam or the first attenuated beam to output the modified first beam having the modified pulse width (PW2) of less than 12 nanoseconds with a modified temporal profile.

6. The apparatus of claim 4, wherein the first beam output from the DPSSL oscillator has a first diameter and wing portions, and wherein the optical filter comprises:
a beam expander configured to expand the modified first beam to a diameter greater than the first diameter; and
an apodizer configured to receive the expanded modified first beam from the beam expander, to remove the wing portions to output the second beam having the second spatial profile without the wing portions.

7. (canceled)

8. The apparatus of claim 1, wherein the output beam from the multi-stage amplifier to a beam delivery device has near field values and measurements, and wherein the laser beam delivery device includes a vacuum relay imaging module (VRIM) configured to maintain the near field values and the measurements of the output beam and to deliver the output beam to the target part.

9. The apparatus of claim 2, further comprising a beam detector coupled to one or a combination of the first polarizer, the second polarizer, and a beam delivery device disposed after the multi-stage amplifier for monitoring one or a combination of:
a beam pulse width, a beam diameter, and an energy level.

10. The apparatus of claim 9, wherein the beam detector generates an error signal from the monitoring to be sent back as a feedback signal to the controller, wherein if a magnitude of the error signal exceeds a defined error range, the feedback signal causes the controller to perform one or a combination of the following:
configure the current source to output a correction current to tune the DPSSL oscillator to counter the pulse width error signal until the pulse width (PW1) stays within the defined tolerance according to the current setting selection;
configure the first pair of the wave plate and the first polarizer to rotate a correction polarization angle to the first beam by an amount to increase or decrease an attenuation of the first energy of the first beam to stay within the defined first energy level;
configure the Pockels cell to switch on or off, or to adjust the modified pulse width (PW2) by an amount to stay within the defined tolerance; and
configure the multi-stage amplifier to adjust one or a combination of the beam energy amplifications and the beam profile modifications to stay within a defined output energy level and a defined beam profile.

11. The apparatus of claim 9, further comprising a first isolator disposed between the DPSSL oscillator and the wave plate, and a second isolator disposed between the multi-stage amplifier and the beam delivery device, wherein the first isolator and the second isolator prevent beam reflections in an opposite direction.

12. A method for pulsed laser beam control, the method comprising:
generating and outputting, by a diode-pumped solid-state laser (DPSSL) oscillator, a pulsed laser beam having predefined beam characteristics corresponding to a current setting selection of a controller;
in response to the current setting selection, the controller controlling a current source to output a current to tune the DPSSL oscillator to generate a first beam having a pulse width (PW1) within a defined tolerance, a first energy, a first spatial profile, and a first temporal profile;
modifying, by an optical filter, a received modified first beam 110 having a modified pulse width (PW2) with a second temporal profile to output a second beam having a second energy, a second spatial profile, and the second temporal profile; and
amplifying a beam energy and modifying a beam profile by a multi-stage amplifier to output an output beam, the amplifying and the modifying comprising:
amplifying and modifying the second beam, by a first stage, to output a third beam having a third energy and a third temporal profile; and
amplifying and modifying the third beam, by a second stage, to output a fourth beam having a fourth energy and a fourth temporal profile, wherein the fourth beam substantially maintains the pulse width (PW1) or the modified pulse width (PW2) within the defined tolerance.

13. The method of claim 12, further comprising attenuating, by a first pair of wave plate and first polarizer, the first energy of the first beam, wherein the first pair of wave plate and first polarizer is disposed at an output of the DPSSL oscillator, and the first pair of wave plate and first polarizer is configured to rotate a polarization angle to the first beam by an amount to attenuate the first energy of the first beam to produce an attenuated first beam not to exceed a defined first energy level.

14. The method of claim 13, further comprising performing, by a second pair of Pockels cell and second polarizer, nanosecond-duration switching on the attenuated first beam, wherein the second pair of Pockels cell and second polarizer is disposed between the first pair of wave plate and first polarizer, and the optical filter, and the second pair of Pockels cell and second polarizer is configured to perform the nanosecond-duration switching on the attenuated first beam, by allowing or preventing the attenuated first beam from exiting of the Pockels cell, wherein an exit beam is the modified first beam having the modified pulse width (PW2) with the second temporal profile.

15. The method of claim 14, wherein the Pockels cell comprises a crystal material containing one of: barium borate or potassium dideuterium phosphate.

16. The method of claim 15, wherein the Pockels cell comprises the crystal material comprising potassium dideuterium phosphate, the Pockels cell is further configured to perform pulse slicing of a leading edge of the first beam or the first attenuated beam to output the modified first beam having the modified pulse width (PW2) of less than 12 nanoseconds with the second temporal profile.

17. The method of claim 14, wherein the first beam output from the DPSSL oscillator has a first diameter and wing portions, and wherein the optical filter comprises:
a beam expander configured to expand the modified first beam to a diameter greater than the first diameter; and
an apodizer configured to receive the expanded modified first from the beam expander, to remove the wing portions to output the second beam having the second spatial profile without the wing portions.

18. (canceled)

19. The method of claim 12, wherein the output beam from the multi-stage amplifier to a beam delivery device has near field values and measurements, and wherein the laser beam delivery device includes a vacuum relay imaging module (VRIM) configured to maintain the near field values and the measurements of the output beam and to deliver the output beam to the target part.

20. The method of claim 13, further comprising using a beam detector to monitor one or a combination of:
a beam pulse width, a beam diameter, and an energy level, wherein the beam detector is coupled to one or a combination of the first polarizer, the second polarizer, and a beam delivery device disposed after the multi-stage amplifier for delivering the output beam from the multi-stage amplifier to a target part.

21. The method of claim 20, further comprising the beam detector generating an error signal from the monitoring to be sent back as a feedback signal to the controller, wherein if a magnitude of the error signal exceeds a defined error range, the feedback signal causes the controller to perform one or a combination of the following:
configuring the current source to output a correction current to tune the DPSSL oscillator to counter the pulse width error signal until the pulse width (PW1) stays within the defined tolerance according to the current setting selection;
configuring the first pair of the wave plate and the first polarizer to rotate a correction polarization angle to the first beam by an amount to increase or decrease an attenuation of the first energy of the first beam to stay within the defined first energy level;
configuring the Pockels cell to switch on or off, or to adjust the modified pulse width (PW2) by an amount to stay within the defined tolerance; and
configuring the multi-stage amplifier to adjust one or a combination of the beam energy amplifications and the beam profile modifications to stay within a defined output energy level and a defined beam profile.

22. The method of claim 20, further comprising preventing beam reflections via a first isolator disposed between the DPSSL oscillator and the wave plate and a second isolator disposed between the multi-stage amplifier and the beam delivery device.
